(19) United States
(12) Patent Application Publication
(10) Pub. No.: US 2024/0430383 A1
(43) Pub. Date: Dec. 26, 2024

(54) Dynamically Rendering Elements In A Virtual Environment

(71) Applicant: QUALCOMM Incorporated, San Diego, CA (US)

(72) Inventors: Vinesh SUKUMAR, Fremont, CA (US); Jonathan KIES, Encinitas, CA (US); Vikram GUPTA, San Diego, CA (US); Tong TANG, Escondido, CA (US); Ananthapadmanabhan Arasanipalai KANDHADAI, San Diego, CA (US); Vasudev BHASKARAN, San Diego, CA (US)

(21) Appl. No.: 18/340,203

(22) Filed: Jun. 23, 2023

(51) Int. Cl. H04N 7/15; G06T 17/00; G06V 40/16; G06V 40/20

(52) U.S. Cl. CPC H04N 7/157; G06T 17/00; G06V 40/174; G06V 40/20; H04N 7/152

(57) ABSTRACT

Embodiment systems and methods for dynamically rendering elements in a virtual environment rendered by the computing device may include monitoring interactions of participants in a virtual environment related to an element or elements presented in the virtual environment, identifying an agreement about the element or elements between at least two of the participants based on the interactions, and altering a presentation of the element or elements in the virtual environment based on the agreement by at least two of the participants.

### BACKGROUND

Communication networks have enabled the development of applications and services for online meetings and gatherings. Some systems provide a virtual environment that presents visual representations of attendees (e.g., avatars) that may range from simplistic or cartoon-like images to photorealistic images. Some of these systems may receive input from a virtual reality (VR) device, such as a VR headset or other VR equipment, that records a user's movement and voice. Such systems may generate a representation of a user's utterances, movements, facial expressions, and even input text based on the user's movements and utterances. However, elements of the virtual environment, such as a representation of the environment itself, or a representation of an item being discussed by participants, are typically predetermined by the system, or imposed on the virtual environment by one participant.

### SUMMARY

Various aspects include methods and computing devices configured to perform the methods for dynamically rendering elements in virtual environments rendered by the computing device. Various aspects may include monitoring interactions of participants in a virtual environment related to an element presented in the virtual environment, identifying an agreement about the element between at least two of the participants based on the interactions, and altering a presentation of the element in the virtual environment based on the agreement about the element.

In some aspects, the interactions of the participants in the virtual environment may be related one or more of a visible aspect, an audible aspect, or a tactile aspect of the element. In some aspects, identifying the agreement about the element between at least two of the participants based on the interactions may be performed based on one or more of words spoken in the virtual environment, user gestures performed in the virtual environment, user emotions detected in the virtual environment, or text conveyed in the virtual environment. In some aspects, altering the presentation of the element in the virtual environment based on the agreement about the element further may include determining a parameter of the element to alter based on the interactions, and altering the presentation of the parameter of the element in the virtual environment based on the agreement.

In some aspects, altering the presentation of the element in the virtual environment based on the agreement about the element may include generating two or more renderings of the element based on the interactions, selecting one of the two or more renderings of the element based on the agreement about the element, and rendering the selected one of the two or more renderings of the element in the virtual environment. Some aspects may include identifying a disagreement about the element based on the interactions, and generating two or more renderings of the element based on the disagreement about the element.

Some aspects may include identifying the agreement about the element may include identifying a selection by the participants of one of the two or more renderings of the element that were generated based on the disagreement about the element. Some aspects may include updating user preference data of at least one of the participants based on the identified agreed-upon element. Some aspects may include updating a generative model used for generating elements of the virtual environment based on the identified agreement about the element.

In some aspects, identifying the agreement about the element may include applying a large language model to words conveyed in the interactions, and receiving as an output from the large language model an identification of the agreement about the element. In some aspects, altering the presentation of the element in the virtual environment based on the agreement about the element is performed using a personalized generative model that is based on user data.

Further aspects may include a computing device including a memory and a processor coupled to the memory and configured with processor-executable instructions to perform operations of any of the methods described above. Further aspects may include processor-readable storage media upon which are stored processor executable instructions configured to cause a controller of a computing device to perform operations of any of the methods described above. Further aspects may include a computing device including means for performing functions of any of the methods described above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of some embodiments.

FIG. 1 is a system block diagram illustrating an example communications system suitable for implementing various embodiments.

FIG. 2 is a component block diagram illustrating an example computing system architecture suitable for implementing various embodiments.

FIG. 3 is a conceptual diagram illustrating aspects of a method for dynamically rendering elements in a virtual environment in accordance with various embodiments.

FIG. 4 is a conceptual diagram illustrating aspects of a system for dynamically rendering elements in a virtual environment in accordance with various embodiments

FIG. 5A is a process flow diagram of an example method performed by a processor of a computing device for dynamically rendering elements in a virtual environment in accordance with various embodiments.

FIGS. 5B-5F are process flow diagrams of operations that may be performed by a processor of a computing device as part of the example for dynamically rendering elements in a virtual environment in accordance with various embodiments.

FIG. 6 is a component block diagram of a network computing device suitable for use with various embodiments.

FIG. 7 is a component block diagram of an example computing device suitable for implementing any of the various embodiments.

FIG. 8 is a component block diagram of a computing device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of various embodiments or the claims.

Various embodiments include methods for dynamically rendering elements in a virtual environment that is rendered by a computing device. Various embodiments enable the computing device to monitor interactions of participants in the virtual environment, and identify agreements between two or more of the participants about one or more elements presented or that could be presented in the virtual environment, such as an object, setting, or experience under discussion. Based on identified agreements between the two or more participants about virtual environment elements, the computing device may alter the presentation of various elements in the virtual environment.

The terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

The term “computing device” is used herein to refer to any one or all of cellular telephones, smartphones, portable computing devices, personal or mobile multi-media players, laptop computers, tablet computers, smartbooks, ultrabooks, palmtop computers, electronic mail receivers, multimedia Internet-enabled cellular telephones, router devices, medical devices and equipment, biometric sensors/devices, wearable devices including smart watches, smart clothing, smart glasses, smart wrist bands, smart jewelry (e.g., smart rings, smart bracelets, etc.), entertainment devices (e.g., gaming controllers, music and video players, satellite radios, etc.), Internet of Things (IoT) devices including smart meters/sensors, industrial manufacturing equipment, large and small machinery and appliances for home or enterprise use, computing devices within autonomous and semiautonomous vehicles, mobile devices affixed to or incorporated into various mobile platforms, global positioning system devices, and similar electronic devices that include a memory and a programmable processor.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single wireless device. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement Global System for Mobile Communications (GSM) Enhanced Data rates for GSM Evolution (EDGE). In another example, an OFDMA network may implement Evolved UTRA (E-UTRA) (including LTE standards), Institute of Electrical and Electronics Engineers (IEEE) 802.11 (WiFi), IEEE 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in the various examples.

The term “virtual reality” (VR) is used herein to visual displays and auditory content that include a computer generated component, and is intended to include any or all of augmented reality (AR), mixed reality (MR), extended reality (XR), and other similar virtual environments or combinations of virtual and real-world visual and auditory environments. Similarly, the term “VR device” is used herein to refer generally to any devices (e.g., head-mounted displays) that present a virtual reality to a user, and is intended to include any or all of AR devices, MR devices, XR devices, and other similar devices for rendering a computer generated virtual environment or combinations of virtual and real-world environments. Similarly, the term “virtual environment” is used herein to refer generally and inclusively to any or all of VR environments, AR environments, MR environments, XR environments, and similar visual and auditory environments provided by a VR device.

The computing device may be configured to render a virtual environment in which users may participate by providing inputs into an end-user computing device, such as VR device (e.g., a VR headset or other suitable VR equipment) that records a user's movement and voice. Such systems may generate a representation of a user's utterances, movements, facial expressions, and even input text based on the user's movements and utterances. The representation of a user's utterances, movements, etc. may be conveyed to other participants in the virtual environment. The computing device also may present a representation of the virtual environment, including environmental features such as a representation of a room, building, outdoor environment, and/or the like, ambient sounds, and other suitable environmental elements. Such a virtual environment may be useful to participants by supplementing or augmenting conversations in business or personal contexts through visually appealing or accurate renderings of content under discussion. Similarly, such a virtual environment may enable highly creative and dynamic virtual workplaces or educational environments. Conventionally, elements of the virtual environment, such as a representation of the environment itself, or a representation of an item being discussed by participants, are typically predetermined by the system, or imposed on the virtual environment by one participant.

Various embodiments include methods and computing devices configured to perform the methods for dynamically rendering elements in a virtual environment rendered by the computing device based upon or in response to agreements reached by participants in the virtual environment. In some embodiments, the computing device may monitor interactions of participants in a virtual environment, such as related to one or more elements (e.g., objects, backgrounds, settings, sounds, furniture, etc.) presented in the virtual environment, and recognize or identify when an agreement between at least two of the participants is reached about one or more elements. Recognition of an agreement by the computing device may be based on the participant interactions, such as spoken words, gestures, body movements (e.g., head nod), facial expressions, and the like. When an agreement on a virtual environment element (currently presented or to be presented) is recognized, the computing device may alter or add presentation of the element or elements in the virtual environment based on the recognized agreement about the element(s). In some embodiments, the interactions of the participants in the virtual environment may be related to a visible aspect of the element, an audible aspect of the element, a tactile aspect of the element, or another suitable aspect of the element. The computing device may monitor any aspect of interactions between participants, including words, sounds, and other utterances, or gestures performed by a participant. In some embodiments, the computing device may monitor a user's tone of voice, pitch, loudness level, intonation, speech cadence, or other distinctive aspects of a user utterance. The computing device may monitor a participant's emotion or emotional expression that is detected (identified, determined) by the system (e.g., based on images of the user's face or user gestures that are captured by VR equipment). The computing device may monitor any suitable aspects of interactions between or among participants in the virtual environment.

In some embodiments, the computing device may identify an agreement about the element(s) based on words spoken in the virtual environment, user gestures performed in the virtual environment, user emotions detected in the virtual environment, or text conveyed (exchanged, sent) between or among participants in the virtual environment. For example, while monitoring interactions among participants, the computing device may determine that a first participant says “we should make the outside of the robot purple,” and that a second participant says “I agree,” and based on these words, the computing device may recognize that there is an agreement about the exterior color of the robot. As another example, the computing device may determine that a first participant says “we should make the outside of the robot purple,” and that a second participant nods his head in agreement. In some embodiments, the computing device may identify an agreement based on a participant's tone of voice, pitch, loudness level, intonation, speech cadence, or other informative aspects of a user utterance. Based on the detected words and the detected gesture, the computing device may identify agreement about the element.

In various embodiments, the computing device may be configured to detect, identify, or determine a wide variety of expressions of meaning or conveyances of meaning by participants. As an example, the computing device may identify that one or more participants is communicating using sign language, and the computing device may identify (detect, determine) meaning conveyed by such participant(s). As another example, the computing device may identify that a participant writes one or more words (e.g., on a virtual notepad, a virtual whiteboard or blackboard) or mimes writing one or more words (e.g., performs writing gestures “in the air”) in which the one or more words manifest agreement (e.g., the participant writes “yes,” “let's do it,” or other suitable words). As another example, the computing device may identify that one or more participants performs an action that indicates or manifest agreement, such as a “thumbs up” hand gesture. As another example, in a virtual environment including virtual whiteboard, the computing device may recognize that a participant selects one of multiple options by writing a check mark next to or circling the option on the virtual whiteboard.

In some embodiments, the computing device may apply a large language model to words spoken (or signed or written) between the participants. In such embodiments, the computing device may receive as an output from the large language model an identification of the agreement about the element.

In some embodiments, the computing device may observe the participants' interaction with each other as well as elements in the virtual environment. The computing device may receive inputs in the form of audio, video, haptic or tactile feedback, heart rates from monitors worn by the users, gaze related data based on a direction of a user's gaze or a user's eye orientation, accelerometer and gyroscope data from devices on users, and other detectable inputs. The computing device may process these inputs to determine whether one or more users are in agreement with (or have agreed on) the presentation of one or more elements in the environment. In some embodiments, the computing device may use words spoken (or signed or written) in conjunction with one or more of the inputs described above, including multi-modal inputs.

The element or elements under discussion by the participants may include an aspect or characteristic of a virtual object in the virtual environment, an aspect or characteristic of a background element of the virtual environment, or any other aspect or characteristic of elements rendered the virtual environment. As an example, participants in the virtual environment may be engaged in a discussion about a robot that the participants are designing, and the element under discussion may include an aspect of the robot. As another example, an element under discussion may include an aspect of the virtual environment, such as a test environment for testing the robot, such as a virtual room, factory floor, etc., which may include obstacles or other objects that the robot must navigate or manipulate.

In various embodiments, the computing device may dynamically alter a presentation of such element in the virtual environment or add such an element to the virtual environment based on an identified agreement between at least two of the participants. In some embodiments, the computing device may determine a parameter of the element(s) to alter based on the interactions, and may alter the presentation of the parameter of the element(s) in the virtual environment based on the agreement. As an example, the computing device may determine that participants are discussing a color or shape of an object in the virtual environment (e.g., a robot). The computing device may determine that at least two of the participants agree on the color of the object, or on that the shape of the object. Based on the identified agreement, the computing device may alter the presentation of the parameter of the element(s), i.e., to render the object in the selected color and shape. As another example, the computing device may determine that at least two of the participants are discussing an aspect of the background or environment (e.g., a factory environment). The computing device may determine that at least two of the participants agree that the factory floor should appear “more industrial,” “cleaner,” “more cluttered,” “should only include manufacturing equipment from one decade earlier,” or another detail, aspect, or characteristic of the environment. Based on the identified agreement, the computing device may alter the presentation of the parameter of the element.

In some embodiments, the computing device may monitor the interactions between two or more participants outside of the virtual environment and use such interactions to determine initial elements of the virtual environment. For example, just prior to the initialization or generation of the virtual environment, the computing device may identify agreement(s) about elements of the virtual environment. For example, the computing device may monitor conversations occurring between users and/or the users' interaction with real world objects (e.g. a robot) using inputs such as audio, video, haptic or tactile feedback, heart rates from monitors worn by the users, gaze related data, accelerometer, and gyroscope data from devices on users, etc. The computing device may process these inputs to determine agreement(s) on elements for the virtual environment. The computing device may use words spoken (or signed or written) in conjunction with the multi-modal inputs outlined above. In some embodiments the computing device may define (identify, generate) the elements of a virtual environment by utilizing historical personal data from one or more participants (e.g., event at users' high school, or a previous meeting on similar topic). The computing device also may use multi-model inputs to determine the elements of interest in the virtual environment and/or refine the environment.

In some embodiments, the computing device may generate two or more renderings of the element based on the interactions, present the options to enable participants to select one of the two or more renderings of the element, and rendering the selected one of the two or more renderings of the element in the virtual environment based on participant agreement on the selection. For example, when discussing the aforementioned robot, participants may discuss, suggest, or propose alternatives. For example, one participant may suggest that the exterior color of the robot should be white, another participant may suggest that the exterior color the robot should be purple, and yet another participant may suggest that the exterior of the robot should have pink polka dots. In response to determining that the participants are discussing options or alternatives of the element, the computing device may generate two or more renderings of the element. In some embodiments, the computing device may present the different renderings as options for the participants to consider. For example, in this example, the computing device may generate three robots, having a white exterior, purple exterior, and a pink polka dotted exterior, respectively. In some embodiments, the computing device may present the different renderings as options for the participants to consider and then recognize an agreement based on selections made by two or more participants.

In some embodiments, the computing device may identify a disagreement about the element based on the interactions. Based on the disagreement about the element, the computing device may generate two or more renderings of the element. In some embodiments, the computing device may present the different renderings as options for the participants to consider. In some embodiments, the computing device may identify the disagreement about the element based on words spoken in the virtual environment, user gestures performed in the virtual environment, user emotions detected in the virtual environment, or text conveyed (exchanged, sent) between or among participants in the virtual environment. For example, in response to a first participant's proposal or suggestion, a second participant may say words such as “no,” “I disagree,” or utterances such as “uh uh,” “nah,” or other another sound that indicates or disapproval. In some embodiments, a trained machine learning model may accurately identify such sounds, even those that are specific to a particular language, a particular language dialect, or a language regional variation. In some embodiments, the computing device may detect sarcasm or other meaning conveyed in a word or utterance (e.g., a phrase such as “yeah yeah” or “suuuuuure” uttered in a sarcastic tone.) Based on the detected words or utterances, the computing device may identify disagreement between participants. In some embodiments, the computing device may apply a large language model to words conveyed in the interactions between the participants. The computing device may apply the large language model to spoken words and/or to text. In such embodiments, the computing device may receive as an output from the large language model an identification of the disagreement about the element.

As another example, the computing device may determine that a first participant says “we should make the outside of the robot purple,” and that a second participant shakes his head in disagreement. Based on the detected words and the detected gesture, the computing device may identify disagreement about the element. As another example, the computing device may identify disagreement in gestural languages as a sign language. As another example, the computing device may identify that a participant writes one or more words (e.g., on a virtual notepad, a virtual whiteboard or blackboard) or mimes writing one or more words (e.g., performs writing gestures “in the air”) in which the one or more words indicating disagreement (e.g., the participant writes “no,” “never,” or other suitable words). As another example, the computing device may identify that one or more participants performs an action that indicates or manifest agreement. For example, in a discussion of a list of options on a virtual whiteboard, the computing device may identify that a participant rejects or negates one of the options, for example, by crossing out (i.e., drawing a line through the words of) the option, or writing an “X” next to the option, on the virtual whiteboard. In various embodiments, the computing device may be configured to detect, identify, or determine other expressions of meaning or conveyances of meaning by a participant.

In response to identifying a disagreement about the element(s) based on the interactions, the computing device may generate two or more renderings of the element based on the disagreement. In some embodiments, the computing device may present the different renderings as options for the participants to consider. The participants may continue discussing the element(s), and may reach agreement about the element(s) under discussion. In some embodiments, the computing device may identify a selection by the participants of one of the two or more renderings of the element(s) that were generated by the computing device based on the disagreement about the element(s). For example, the computing device may determine that a participant indicates agreement using words (e.g., “I agree,” “okay,” and the like), gestures (e.g., pointing at a selected rendering, nodding one's head in agreement, or another suitable gesture), text (e.g., writing words of agreement), or another suitable indication of agreement. In some embodiments, in response to detecting the agreement about the element, the computing device may remove (erase, de-spawn, render invisible) rendering(s) of the element that the participants did not agree on.

In various embodiments, the computing device may render or generate elements based on parameters or other information stored in user preference data of at least one of the participants. In some embodiments, the computing device may apply one or more generative models (such as generative artificial intelligence (AI) models) to generate elements of the virtual environment, including elements based on an identified agreement about such elements. In some embodiments, the computing device may apply user preference data to one or more generative models used to generate elements of the virtual environment, to personalize such generative model(s) for each user. In some embodiments, the computing device may use such personalized generative models for generating a presentation of an element, or altering presentation of an element, in the virtual environment. For example, based on an agreement about an element in the virtual environment, the computing device may alter the presentation of that element using a personalized generative model that is based on user data. In some embodiments, based on the identified agreed-upon element (or an agreed-upon aspect or parameter of the element) the computing device may update a participant's user preference data. In some embodiments, based on the identified agreed-upon element (or an agreed-upon aspect or parameter of the element) the computing device may update one or more of the generative models used for generating elements of the virtual environment.

In various embodiments, the computing device may obtain user data and user preferences from a variety of sources, and may apply such user data to personalize user preferences, update generative models, and or generate personalized virtual environment themes for a user. Such user data may be labeled or unlabeled, and may include data from a user's social media, web browsing, and/or location history. The user data may include metadata expressing or indicating a user's prior choices, preferences, rankings, or other selections regarding elements in virtual environments. In some embodiments, the computing device may obtain user data from sensor data of an end-user device (e.g., VR device), as well as from past interactions in virtual environments. The computing device also may obtain user data via inputs from the user, including responses to prompts presented by the computing device. The computing device may obtain user data by observing the output of a user's personalized generative models. In some embodiments, such user data also may include default or primary environmental settings such as brightness levels, color selections or pallets, background media, and/or the like. In various embodiments, the computing device may apply such user data to customize aspects of inanimate object attributes, or animate object attributes (e.g., a user preference that a virtual pet is active, inactive, etc.).

In some embodiments, the computing device may apply user data to generate personalized themes for rendering elements in the virtual environment. In some embodiments, the computing device may generate one or more categories, and may generate one or more themes within each category. The computing device may obtain the user data for generating personalized themes over time by observing user behavior in the virtual environment and/or by direct feedback or input from the user.

In some embodiments, the computing device may apply user data to generate personalized generative models configured to provide as output elements for rendering in the virtual environment. Such personalized generative models may reflect user preferences for various elements or content within the virtual environment, such as brightness levels, background settings, audio element such as music or background noise, and/or the like. In some embodiments, the personalized generative models may reflect priorities or a prioritization determined over time of content attributes preferred by the user. In some embodiments, such attributes may be prioritized using preferences of the user.

Various embodiments may improve the operation of computing devices by enabling the dynamic generation and alteration of elements in a virtual environment. Various embodiments may improve the operation of computing devices by enabling a computing device to monitor interactions of participants in the virtual environment, and to identify an agreement between two or more of the participants about an element presented in the virtual environment, such as an element under discussion, and dynamically alter a presentation of the element in the virtual environment.

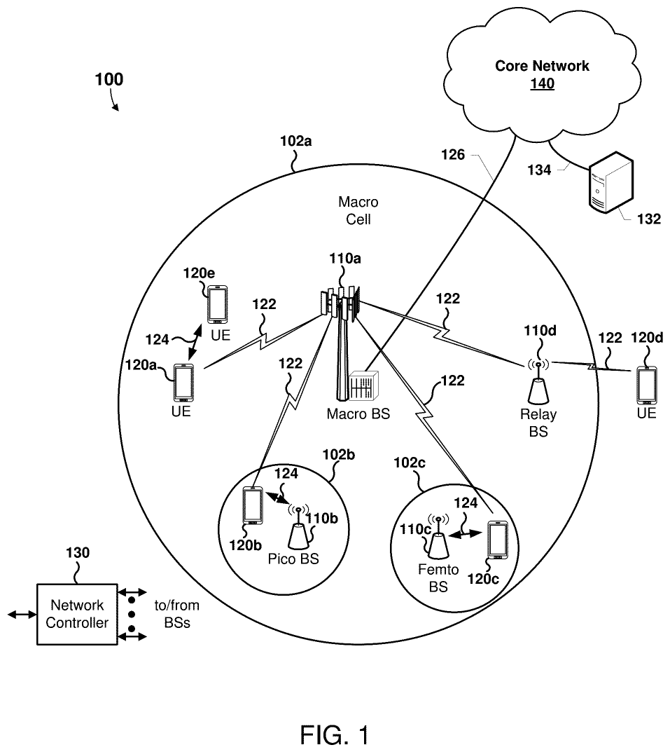

FIG. 1 is a system block diagram illustrating an example communications system 100 suitable for implementing various embodiments. The communications system 100 may be a 5G New Radio (NR) network, or any other suitable network such as a Long Term Evolution (LTE) network. While FIG. 1 illustrates a 5G network, later generation networks may include the same or similar elements. Therefore, the reference to a 5G network and 5G network elements in the following descriptions is for illustrative purposes and is not intended to be limiting.

The communications system 100 may include a heterogeneous network architecture that includes a core network 140 and a variety of wireless devices (illustrated as wireless devices 120a-120e in FIG. 1). The communications system 100 also may include a number of base stations (illustrated as the BS 110a, the BS 110b, the BS 110c, and the BS 110d) and other network entities. A base station is an entity that communicates with wireless devices, and also may be referred to as a Node B, an LTE Evolved nodeB (eNodeB or eNB), an access point (AP), a Radio head, a transmit receive point (TRP), a New Radio base station (NR BS), a 5G NodeB (NB), a Next Generation NodeB (gNodeB or gNB), or the like. Each base station may provide communication coverage for a particular geographic area. In 3GPP, the term “cell” can refer to a coverage area of a base station, a base station subsystem serving this coverage area, or a combination thereof, depending on the context in which the term is used. The core network 140 may be any type core network, such as an LTE core network (e.g., an evolved packet core (EPC) network), a 5G core network, etc. The core network 140 may communicate with a network computing device 132. The network computing device 132 may be configured to perform operations to provide a variety of services, including providing a virtual environment as described in more detail below.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted access by wireless devices with service subscription. A pico cell may cover a relatively small geographic area and may allow unrestricted access by wireless devices with service subscription. A femto cell may cover a relatively small geographic area (for example, a home) and may allow restricted access by wireless devices having association with the femto cell (for example, wireless devices in a closed subscriber group (CSG)). A base station for a macro cell may be referred to as a macro BS. A base station for a pico cell may be referred to as a pico BS. A base station for a femto cell may be referred to as a femto BS or a home BS. In some embodiments, a base station 110a may be a macro BS for a macro cell 102a, a base station 110b may be a pico BS for a pico cell 102b, and a base station 110c may be a femto BS for a femto cell 102c. A base station 110a-110d may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not be stationary, and the geographic area of the cell may move according to the location of a mobile base station. In some examples, the base stations 110a-110d may be interconnected to one another as well as to one or more other base stations or network nodes (not illustrated) in the communications system 100 through various types of backhaul interfaces, such as a direct physical connection, a virtual network, or a combination thereof using any suitable transport network

The communications system 100 also may include relay stations (such as relay BS 110d). A relay station is an entity that can receive a transmission of data from an upstream station (for example, a base station or a wireless device) and send a transmission of the data to a downstream station (for example, a wireless device or a base station). A relay station also may be a wireless device that can relay transmissions for other wireless devices. In the example illustrated in FIG. 1, a relay station 110d may communicate with macro the base station 110a and the wireless device 120d in order to facilitate communication between the base station 110a and the wireless device 120d. A relay station also may be referred to as a relay base station, a relay base station, a relay, etc.

The communications system 100 may be a heterogeneous network that includes base stations of different types, for example, macro base stations, pico base stations, femto base stations, relay base stations, etc. These different types of base stations may have different transmit power levels, different coverage areas, and different impacts on interference in communications system 100. For example, macro base stations may have a high transmit power level (for example, 5 to 40 Watts) whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The wireless devices 120a, 120b, 120c may be dispersed throughout communications system 100, and each wireless device may be stationary or mobile. A wireless device also may be referred to as an access terminal, a terminal, a mobile station, a subscriber unit, a station, user equipment (UE), an end-user device, etc.

The base stations 110a-110d may communicate with the core network 140 over a wired or wireless communication link 126. The wireless devices 120a, 120b, 120c may communicate with the base station 110a-110d over a wireless communication link 122. The core network 140 may enable communication between the wireless devices 120a-120e and the network computing device 132 via a wired or wireless communication link 134. A macro base station 110a may communicate with the communication network 140 over a wired or wireless communication link 126. The wireless communication links 122 and 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as WiFi, LTE-U, LTE-Direct, LAA, MuLTEfire, and relatively short range RATs such as ZigBee, Bluetooth, and Bluetooth Low Energy (LE).

The wired communication links 126 and 134 may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHZ (i.e., 6 resource blocks), and there may be 1, 2, 4, 8 or 16 subbands for system bandwidth of 1.25, 2.5, 5, 10 or 20 MHz, respectively.

While descriptions of some implementations may use terminology and examples associated with LTE technologies, some implementations may be applicable to other wireless communications systems, such as a new radio (NR) or 5G network. NR may utilize OFDM with a cyclic prefix (CP) on the uplink (UL) and downlink (DL) and include support for half-duplex operation using time division duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding also may be supported. MIMO configurations in the DL may support up to eight transmit antennas with multi-layer DL transmissions up to eight streams and up to two streams per wireless device. Multi-layer transmissions with up to 2 streams per wireless device may be supported. Aggregation of multiple cells may be supported with up to eight serving cells. Alternatively, NR may support a different air interface, other than an OFDM-based air interface.

Some wireless devices may be considered machine-type communication (MTC) or evolved or enhanced machine-type communication (eMTC) wireless devices. MTC and eMTC wireless devices include, for example, robots, drones, remote devices, sensors, meters, monitors, location tags, etc., that may communicate with a base station, another device (for example, remote device), or some other entity. A wireless computing platform may provide, for example, connectivity for or to a network (for example, a wide area network such as Internet or a cellular network) via a wired or wireless communication link. Some wireless devices may be considered Internet-of-Things (IoT) devices or may be implemented as NB-IoT (narrowband internet of things) devices. The wireless device 120a-120e may be included inside a housing that houses components of the wireless device 120a-120e, such as processor components, memory components, similar components, or a combination thereof.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an evolved packet core (EPC) network) in a 5G NSA network. Other example network configurations may include a 5G standalone (SA) network in which a 5G/NR RAN connects to a 5G core network.

In some implementations, two or more wireless devices (for example, illustrated as the wireless device 120a and the wireless device 120e) may communicate directly using one or more sidelink channels (for example, without using a base station 110a-110d as an intermediary to communicate with one another). For example, the wireless devices 120a-120e may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In this case, the wireless device 120a-120e may perform scheduling operations, resource selection operations, as well as other operations described elsewhere herein as being performed by the base station 110a-110d.

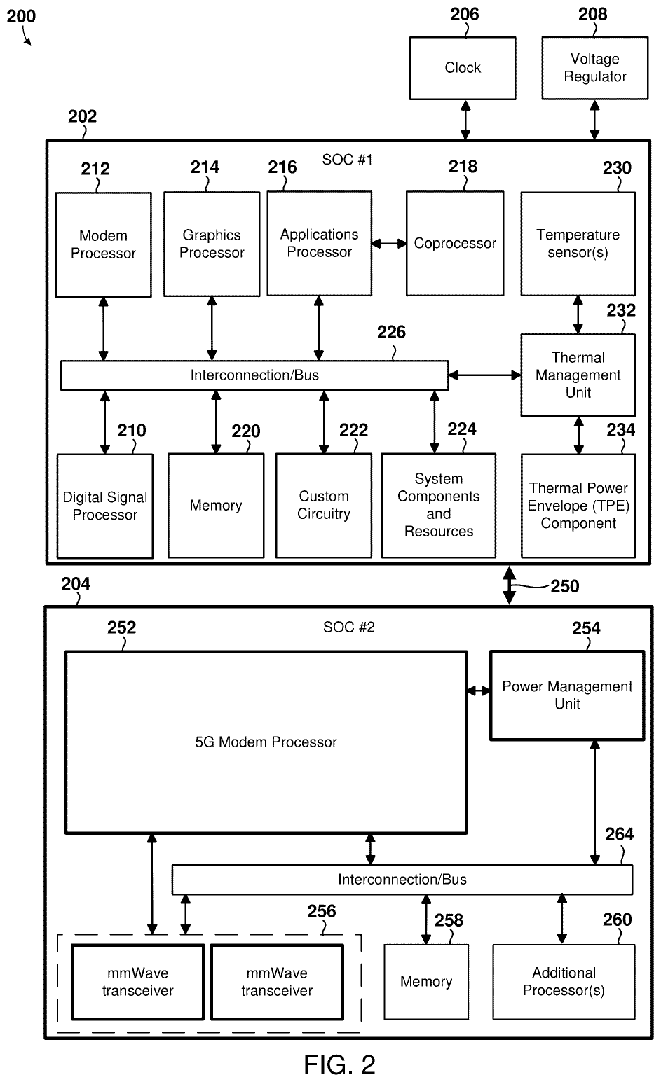

FIG. 2 is a component block diagram illustrating an example computing system 200 architecture suitable for implementing various embodiments. With reference to FIGS. 1 and 2, various embodiments may be implemented on a number of single processor and multiprocessor computer systems, including a system-on-chip (SOC) or system in a package (SIP). The computing system 200 may include a two SOCs 202, 204, a clock 206, and a voltage regulator 208. In some embodiments, the first SOC 202 operate as central processing unit (CPU) of the wireless device that carries out the instructions of software application programs by performing the arithmetic, logical, control and input/output (I/O) operations specified by the instructions. In some embodiments, the second SOC 204 may operate as a specialized processing unit. For example, the second SOC 204 may operate as a specialized 5G processing unit responsible for managing high volume, high speed (e.g., 5 Gbps, etc.), and/or very high frequency short wavelength (e.g., 28 GHz mmWave spectrum, etc.) communications.

The first SOC 202 may include a digital signal processor (DSP) 210, a modem processor 212, a graphics processor 214, an application processor 216, one or more coprocessors 218 (e.g., vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 252, 260 may be included as part of a processor cluster architecture (e.g., a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 and/or custom circuitry 222 may also include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (e.g., clock 206, voltage regulator 208) may be shared by two or more of the internal SOC processors/cores.

In addition to the example computing system 200 discussed above, various embodiments may be implemented in a wide variety of computing systems, which may include a single processor, multiple processors, multicore processors, or any combination thereof.

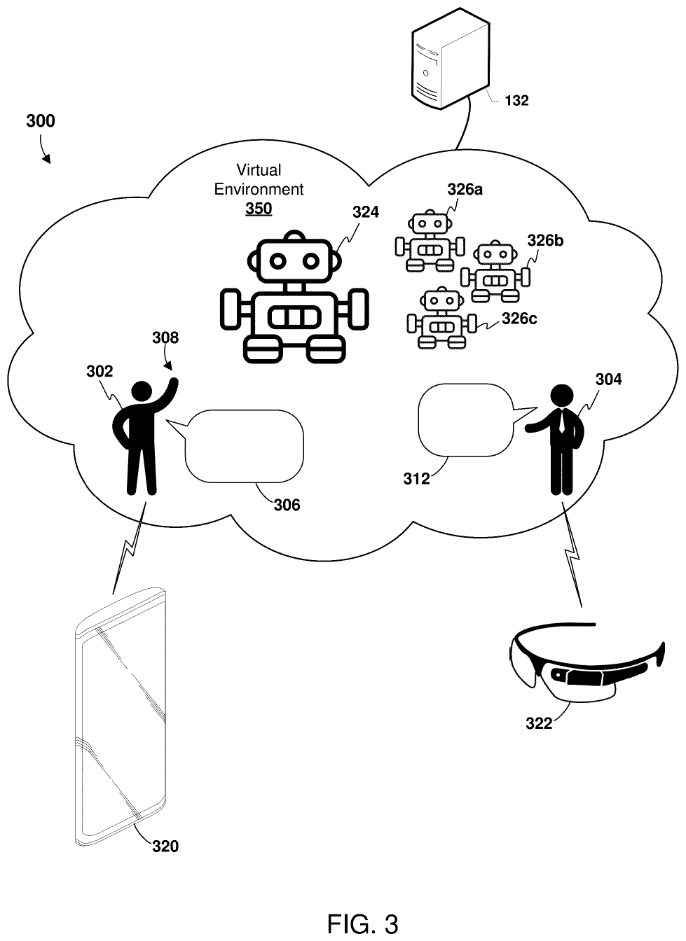

FIG. 3 is a conceptual diagram illustrating aspects of a method 300 for dynamically rendering elements in a virtual environment in accordance with various embodiments. With reference to FIGS. 1-3, a processor (e.g., 210, 212, 214, 216, 218, 252, 260) of a computing device (e.g., 132) may be configured to provide a virtual environment 350, and to dynamically render elements in the virtual environment 350, via a communications network or communications system (aspects of which are discussed above with respect to the communications system 100). The method 300 may be implemented in the computing device using any combination of hardware elements and/or software elements.

In some embodiments, the virtual meeting 350 may include one or more representations of participants, such as a first participant 302 and a second participant 304, each of whom may participate via a computing device such as the computing devices 320 and 322. In various embodiments, the virtual meeting 430 may include any number of participants.

The participants 302, 304 may engage in interactions in the virtual environment. In some embodiments, each participant 302, 304 may move their respective representations around the virtual environment 350 and may interact with virtual objects in the virtual environment 350. Each participant 302, 304 also may interact with another participant via various forms of communication. For example, the participants 302, 304 may emit utterances 306, 312, including words and other communicative sounds. The participants 302, 304 may perform gestures 308. The participants 302, 304 also may express emotions through words, gestures, facial expressions, and the like. Device sensors of the computing devices 320 and 322 may receive inputs from end users (e.g., cameras, microphones, motion sensors, haptic sensors, and other suitable device sensors), and may based on such received inputs may transmit information indicative of communication to the virtual environment 350 via the computing device 132.

The virtual environment 350 may include a variety of elements, including background elements, environmental elements, foreground elements, virtual objects with which a participant may interact, and other suitable virtual elements. The virtual environment 350 may include an element that the participants 302, 304 are discussing, such as element 324 (represented in this example as a robot, but which may be any suitable element of the virtual environment 350). In various embodiments, the computing device 132 may monitor interactions of the participants 302, 304 in the virtual environment 350 related to the element 324 presented in the virtual environment. The computing device 132 may identify an agreement about the element between at least two of the participants based on the interactions. The computing device 132 may alter a presentation of the element 324 the virtual environment 350 based on the agreement about the element 324.

In some embodiments, the computing device 132 may generate two or more renderings of the element under discussion, such as alternatives 326a, 326b, and 326c. For example, the computing device 132 may identify that the participants 302 and 304 are discussing alternatives of the element 324, or alternatives of an aspect of the element 324. In response to identifying that the participants 302, 304 are discussing alternatives of the element 324, the computing device 132 may generate multiple alternatives, e.g., 326a, 326b, 326c, that show or demonstrate the alternatives under discussion. The computing device 132 may identify that the participants 302, 304 have reached agreement on, selected, or identified one of the alternatives 326a, 326b, 326c. In response to identifying the agreement on one of the alternatives 326a, 326b, 326c, the computing device may render the selected rendering of the element in the virtual environment. In some embodiments, the computing device also may erase or de-spawn of the alternatives that were not selected.

In some embodiments, the computing device 132 may identify a disagreement between the participants 302, 304 about an element 324. In response to identifying the disagreement about the element 324, the computing device 132 may generate two or more renderings of the element (e.g., 326a, 326b, 326c) based on the disagreement. The computing device 132 also may identify a subsequent agreement by the participants 302, 304 of one of the alternative renderings of the element 326a, 326b, 326c.

Although the alternative renderings of the element 326a, 326b, 326c are depicted in this example as robots, the two or more renderings of the element may be renderings of any element or aspect of an element in the virtual environment, including ambient or environmental elements, background elements, foreground elements, virtual objects, or any aspect thereof, including any combination thereof.

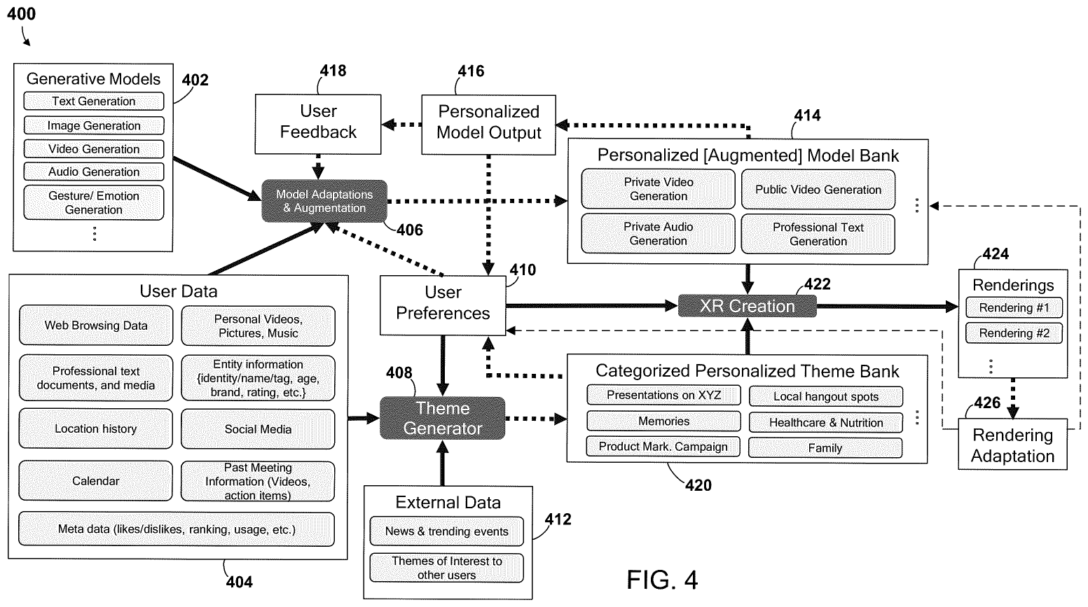

FIG. 4 is a conceptual diagram illustrating aspects of a system 400 for dynamically rendering elements in a virtual environment in accordance with various embodiments. With reference to FIGS. 1-4, the system 400 may be implemented by a processor (e.g., 210, 212, 214, 216, 218, 252, 260) of a computing device (e.g., 132). The system 400 may include generative models 402, user data 404, user preferences 410, external data 412, a personalized model bank 414, and a personalized theme bank 420. The elements of the system 400 and any operations performed by such elements may be implemented in the computing device using any combination of hardware elements and/or software elements.

The generative models 402 may include models configured to generate elements for use in in a virtual environment, and may include a text generation model, and image generation model, video generation model, and audio generation model, gesture or emotion generation models, and/or other suitable generative models. The user data 404 may include a variety of information specific to a particular user that may participate in a virtual environment. The user data 404 may include, for example, web browsing data; professional tax documents and media; a location history of the user and/or the user's computing device; calendar information; personal videos, pictures, and/or music; identifying information such as a user identifier, a name, user ID tag, a user's age; and/or a brand associated with the user data, and/or a rating associated with the user or user data. The user data 404 also may include information associated with the user from one or more social media services, streams, posts, or other information associated with the user. The user data 404 also may include historical information associated with the user, such as information from earlier virtual meetings, including images, videos, action items generated during a virtual meeting, or any other suitable historical information. The user data 404 also may include metadata associated with any of the user data, including preferences such as likes or dislikes, a ranking of any such user data, usage history of any user data, and/or the like.

The user preferences 410 may include any of a variety of user inputs, user presets, user preferences, or other suitable user preference information. The external data 412 may include information received by the computing device from sources external to the computing device, such as information about news and trending events, seems that may be of interest to users, including crowdsourced information (e.g., information of interest to other users).

The system 400 may generate and/or update personalized model bank 414 that includes one or more generative models that are altered, modified, or trained over time to provide personalized model output 416. The personalized model output 416 may include image or video elements, audio elements, and/or other elements suitable for presentation in a virtual environment. For example, the personalized model bank 414 may include a private video generation model, a private audio generation model, public video generation model, a professional text generation model, and or other suitable personalized models.

In one example of altering, modifying, or training the generative models of the personalized model bank 414, one or more of the generative models 402 may provide as output initial elements 406 suitable for use in a virtual environment. In some embodiments, the initial elements 406 may be generated or modified based on the user data 404 and/or the user preferences 410. In some embodiments, the system 400 may use the initial elements to establish initial conditions for the generative models of the personalized model bank 414. The models of the personalized model bank 414 may provide as output the personalized model output 416. The user may provide user feedback 418 related to the personalized model output 416. The user feedback 418 may include alterations to the personalized model output 416, and input increasing or decreasing a weight or value associated with an aspect of the personalized model output 416 (e.g., an acceptance input, rejection input, a “like,” a “display,” or other suitable user feedback). The system 400 may alter or modify the initial elements 406 based on the user feedback 418. The system also may use the altered or modified initial elements 416 to alter, modify, or train one or more personalized models 414.

The system 400 may provide as input into a theme generator 408 information from the user data, the user preferences 410, and/or the external data 412. The system 400 may receive as output from the theme generator 408 one or more elements that the system may store in or add to the personalized theme bank 420. The personalized theme bank 420 may include one or more elements, or aspects or parameters of elements, suitable for use in generating elements in a virtual environment.

The system 400 also may include an extended reality (XR) creation module 422. The system 400 may provide as inputs to the XR creation module 422 information from the personalized model bank 414, the user preferences 410, and/or the personalized theme bank 420. The XR creation module 422 may generate as output one or more renderings 424 of elements for use in a virtual environment. In various embodiments, the XR creation module 422 also may alter a presentation (e.g., rendering adaptation 426) of any of the elements in the virtual environment. In some embodiments, the system may use the altered presentation of an element, or a parameter of the altered presentation of an element, to update one or more of the models of the personalized model bank 414, and/or information in the user preferences 410.

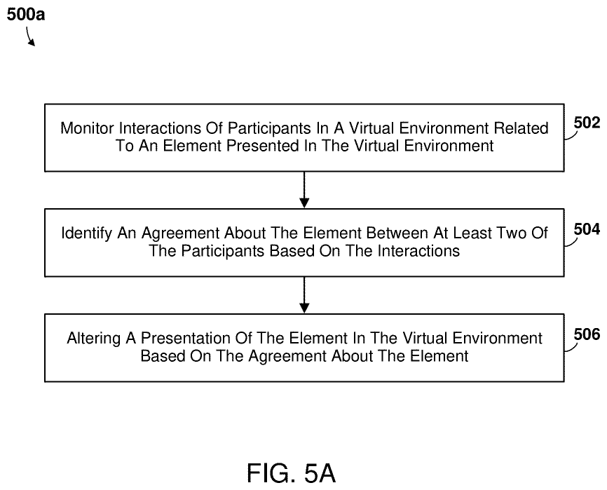

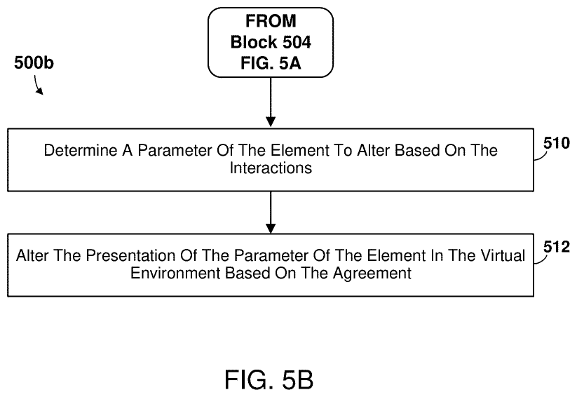

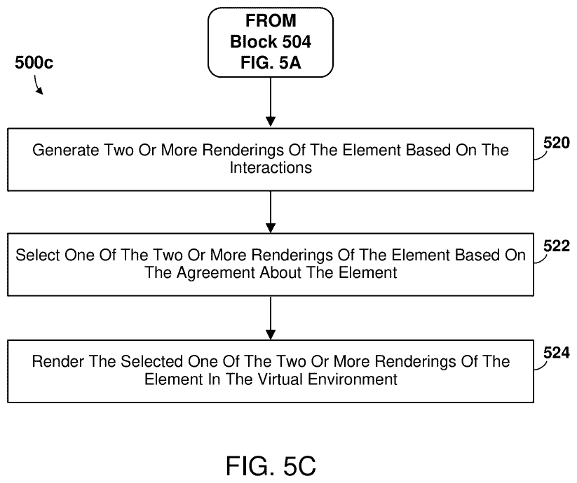

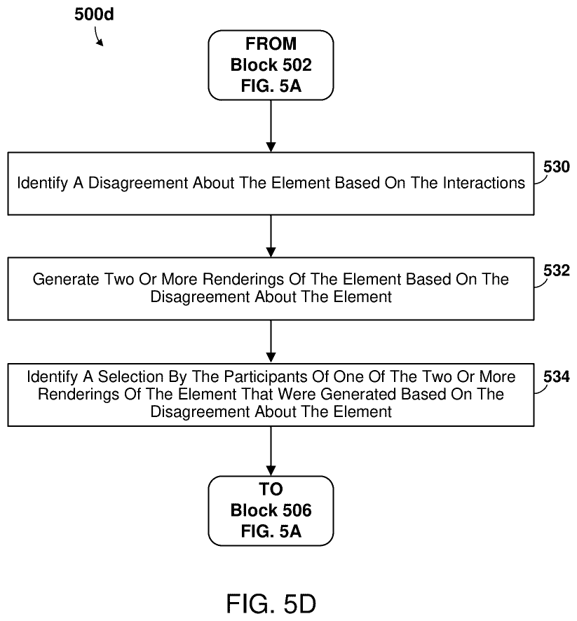

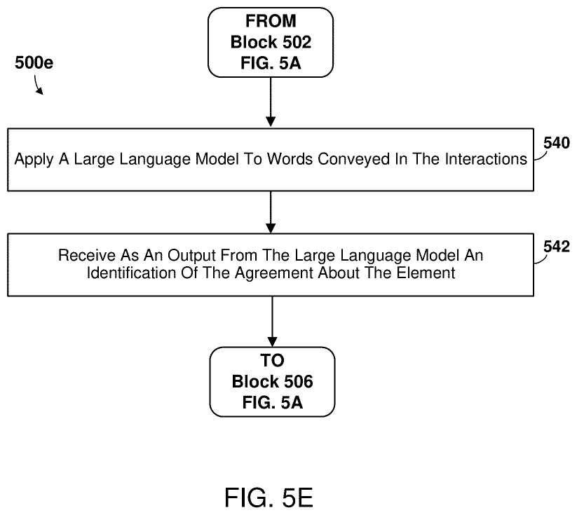

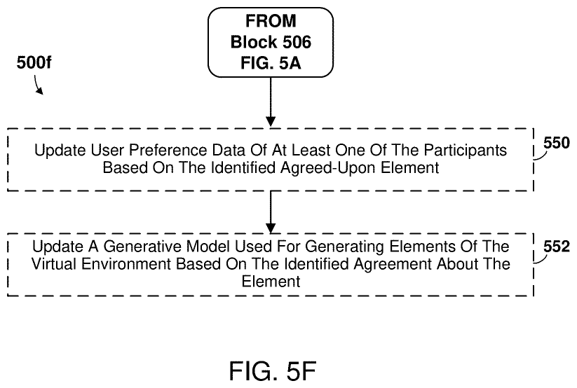

FIG. 5A is a process flow diagram of an example method 500a performed by a processor of a computing device for dynamically rendering elements in a virtual environment in accordance with various embodiments. With reference to FIGS. 1-5A, means for performing the operations of the method 500a may be a processing system of a computing device (e.g., 132, 200) as described herein. A processing system may include one or more processors (e.g., processor 210, 212, 214, 216, 218, 252, 260) and/or hardware elements, any one or combination of which may be configured to perform any of the operations of the method 500a. Further, one or more processors within a processing system may be configured with software or firmware, to perform various operations of the method. To encompass any of the processor(s), hardware elements and software element that may be involved in performing the method 500a, the elements performing method operations are referred to generally as a “processing system.”

In block 502, the processing system may monitor interactions of participants in a virtual environment related to an element presented in the virtual environment. In some embodiments, the interactions of the participants in the virtual environment may be related one or more of a visible aspect, an audible aspect, or a tactile aspect of the element.

In block 504, the processing system may identify an agreement about the element between at least two of the participants based on the interactions. In some embodiments, the processor may identify the agreement based on one or more of words spoken in the virtual environment, user gestures performed in the virtual environment, user emotions detected in the virtual environment, or text conveyed in the virtual environment.

In block 506, the processing system may alter a presentation of the element in the virtual environment based on the agreement about the element. In some embodiments, the processor may alter the presentation of the element in the virtual environment using a personalized generative model that is based on user data.

FIGS. 5B-5F are process flow diagrams of operations 500b-500f that may be performed by a processor of a computing device as part of the method 500a for dynamically rendering elements in a virtual environment in accordance with various embodiments. With reference to FIGS. 1-5F, means for performing the operations of the operations 500b-500f may be a processing system of a computing device (e.g., 132, 200). A processing system may include one or more processors (e.g., processor 210, 212, 214, 216, 218, 252, 260) and/or hardware elements, any one or combination of which may be configured to perform any of the operations of the methods 500b-500f. Further, one or more processors within a processing system may be configured with software or firmware, to perform various operations of the method. To encompass any of the processor(s), hardware elements and software element that may be involved in performing the methods 500b-500f, the elements performing method operations are referred to generally as a “processing system.”

Referring to FIG. 5B, after identifying an agreement about the element between at least two of the participants based on the interactions in block 504 of the method 500a as described, the processor may determine a parameter of the element to alter based on the interactions in block 510.

In block 512, the processor may alter the presentation of the parameter of the element in the virtual environment based on the agreement

Referring to FIG. 5C, after identifying an agreement about the element between at least two of the participants based on the interactions in block 504 of the method 500a as described, the processor may generate two or more renderings of the element based on the interactions in block 520.

In block 522, the processor may select one of the two or more renderings of the element based on the agreement about the element.

In block 524, the processor may render the selected one of the two or more renderings of the element in the virtual environment.

Referring to FIG. 5D, after monitoring interactions of participants in a virtual environment related to an element presented in the virtual environment in block 502 of the method 500a as described, the processor may identify a disagreement about the element based on the interactions in block 530.

In block 532, the processor may generate two or more renderings of the element based on the disagreement about the element.

In block 534, the processor may identify a selection by the participants of one of the two or more renderings of the element that were generated based on the disagreement about the element.

The processor may alter a presentation of the element in the virtual environment based on the agreement about the element in block 506 of the method 500a as described.

Referring to FIG. 5E, after monitoring interactions of participants in a virtual environment related to an element presented in the virtual environment in block 502 of the method 500a as described, the processor may apply a large language model to words conveyed in the interactions in block 540. Words conveyed in the interactions may include speech, text, or other verbal or textual information.

In block 542, the processor may receive as an output from the large language model an identification of the agreement about the element.

The processor may alter a presentation of the element in the virtual environment based on the agreement about the element in block 506 of the method 500a as described.

Referring to FIG. 5F, after altering a presentation of the element in the virtual environment based on the agreement about the element in block 506 of the method 500a as described, the processor may optionally update user preference data of at least one of the participants based on the identified agreed-upon element in optional block 550. For example, the processor may update information stored in the user preference data 410.

In optional block 552, the processor may update a generative model used for generating elements of the virtual environment based on the identified agreement about the element. For example, the processor may update a model in the personalized model bank 414.

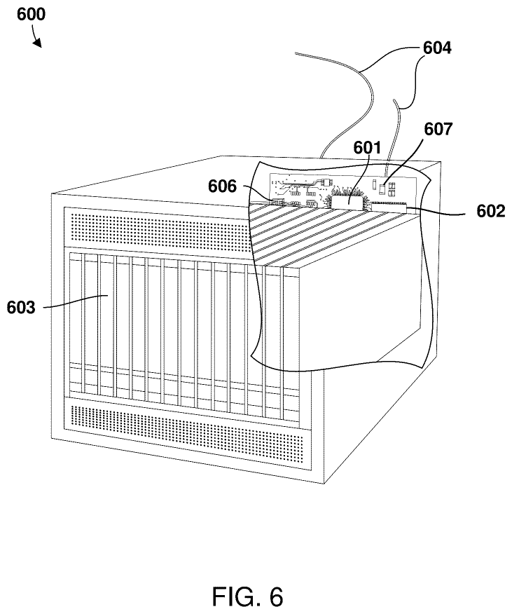

FIG. 6 is a component block diagram of a network computing device 600 suitable for use with various embodiments. With reference to FIGS. 1-6, various embodiments (including, but not limited to, embodiments discussed above with reference to FIGS. 1-5F) may be implemented on a variety of network computing devices, an example of which is illustrated in FIG. 6 in the form of a network computing device 600. The network computing device 600 may include a processor 601 coupled to volatile memory 602 and a large capacity nonvolatile memory, such as a disk drive 603. The network computing device 600 may also include a peripheral memory access device such as a floppy disc drive, compact disc (CD) or digital video disc (DVD) drive 606 coupled to the processor 601. The network computing device 600 may also include network access ports 604 (or interfaces) coupled to the processor 601 for establishing data connections with a network, such as the Internet and/or a local area network coupled to other system computers and servers. The network computing device 600 may include one or more transceivers 607 for sending and receiving electromagnetic radiation that may be connected to a wireless communication link. The network computing device 600 may include additional access ports, such as USB, Firewire, Thunderbolt, and the like for coupling to peripherals, external memory, or other devices.

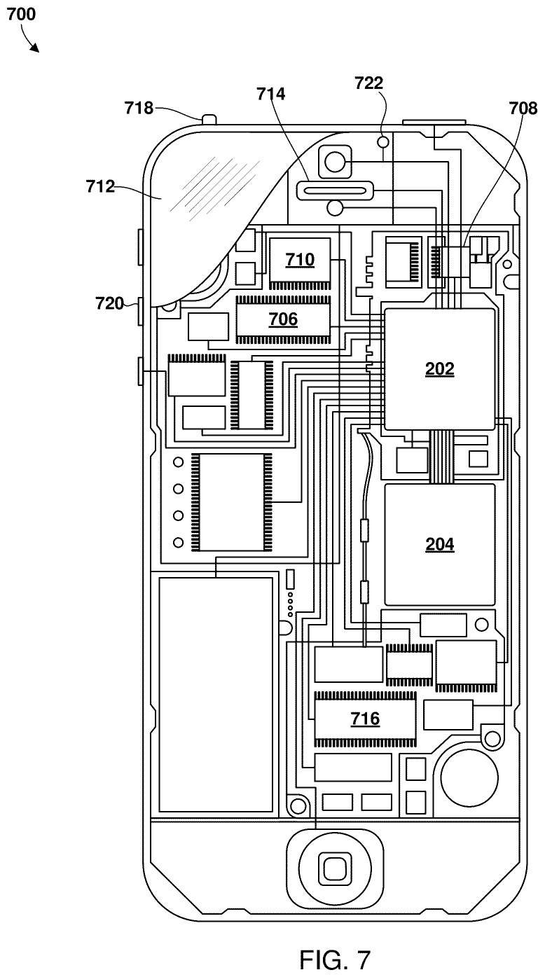

FIG. 7 is a component block diagram of an example computing device 700 suitable for implementing any of the various embodiments. With reference to FIGS. 1-7, the computing device 700 may include a first System-On-Chip (SOC) processor 202 (such as a SOC-CPU) coupled to a second SOC 204 (such as a 5G capable SOC). The first and second SOCs 202, 204 may be coupled to internal memory 706, 716, a display 712, and to a speaker 714. Additionally, the computing device 700 may include an antenna 718 for sending and receiving electromagnetic radiation that may be connected to a wireless data link and/or wireless transceiver 708 coupled to one or more processors in the first and/or second SOCs 202, 204. The one or more processors may be configured to determine signal strength levels of signals received by the antenna 718. The computing device 700 may also include menu selection buttons or rocker switches 720 for receiving user inputs. In addition, soft virtual buttons may be presented on display 712 for receiving user inputs.

The computing device 700 may also include a sound encoding/decoding (CODEC) circuit 710, which digitizes sound received from a microphone into data packets suitable for wireless transmission and decodes received sound data packets to generate analog signals that are provided to the speaker to generate sound. Also, one or more of the processors in the first and second SOCs 202, 204, wireless transceiver 708 and CODEC 710 may include a digital signal processor (DSP) circuit (not shown separately). The computing device 700 may also include one or more optical sensors 722, such as a camera. The optical sensors 722 may be coupled to one or more processors in the first and/or second SOCs 202, 204 to control operation of and to receive information from the optical sensor(s) 722 (e.g., images, video, and the like).

The processors (e.g., SOCs 202, 204) of the computing device 700 may be any programmable microprocessor, microcomputer or multiple processor chip or chips that can be configured by software instructions (applications) to perform a variety of functions, including the functions of the various embodiments described below. In some wireless devices, multiple processors may be provided, such as one processor within an SOC 204 dedicated to wireless communication functions and one processor within an SOC 202 dedicated to running other applications.

Typically, software applications including processor-executable instructions may be stored in non-transitory processor-readable storage media, such as the memory 706, 716, before the processor-executable instructions are accessed and loaded into the processor. The processors 202, 204 may include internal memory sufficient to store the application software instructions. The computing device 700 may also include optical sensors such as a camera (not shown).

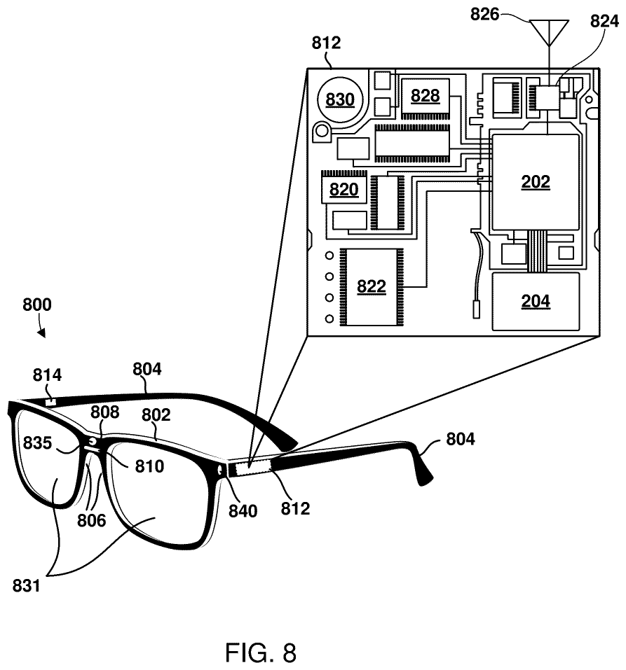

FIG. 8 is a component block diagram of a computing device 800 suitable for use with various embodiments. With reference to FIGS. 1-8, various embodiments (including embodiments discussed above with reference to FIGS. 1-5F) may be implemented on a variety of computing devices, an example of which is illustrated in FIG. 8 in the form of smart glasses 800. The smart glasses 800 may operate like conventional eyeglasses, but with enhanced computer features and sensors, like a built-in camera 835 and heads-up display or AR features on or near the lenses 831. Like any glasses, smart glasses 800 may include a frame 802 coupled to temples 804 that fit alongside the head and behind the ears of a wearer. The frame 802 holds the lenses 831 in place before the wearer's eyes when nose pads 806 on the bridge 808 rest on the wearer's nose.

In some embodiments, smart glasses 800 may include an image rendering device 814 (e.g., an image projector), which may be embedded in one or both temples 804 of the frame 802 and configured to project images onto the optical lenses 831. In some embodiments, the image rendering device 814 may include a light-emitting diode (LED) module, a light tunnel, a homogenizing lens, an optical display, a fold mirror, or other components well known projectors or head-mounted displays. In some embodiments (e.g., those in which the image rendering device 814 is not included or used), the optical lenses 831 may be, or may include, see-through or partially see-through electronic displays. In some embodiments, the optical lenses 831 include image-producing elements, such as see-through Organic Light-Emitting Diode (OLED) display elements or liquid crystal on silicon (LCOS) display elements. In some embodiments, the optical lenses 831 may include independent left-eye and right-eye display elements. In some embodiments, the optical lenses 831 may include or operate as a light guide for delivering light from the display elements to the eyes of a wearer.

The smart glasses 800 may include a number of external sensors that may be configured to obtain information about wearer actions and external conditions that may be useful for sensing images, sounds, muscle motions and other phenomenon that may be useful for detecting when the wearer is interacting with a virtual user interface as described. In some embodiments, smart glasses 800 may include a camera 835 configured to image objects in front of the wearer in still images or a video stream. Additionally, the smart glasses 800 may include a lidar sensor 840 or other ranging device. In some embodiments, the smart glasses 800 may include a microphone 810 positioned and configured to record sounds in the vicinity of the wearer. In some embodiments, multiple microphones may be positioned in different locations on the frame 802, such as on a distal end of the temples 804 near the jaw, to record sounds made when a user taps a selecting object on a hand, and the like. In some embodiments, smart glasses 800 may include pressure sensors, such on the nose pads 806, configured to sense facial movements for calibrating distance measurements. In some embodiments, smart glasses 800 may include other sensors (e.g., a thermometer, heart rate monitor, body temperature sensor, pulse oximeter, etc.) for collecting information pertaining to environment and/or user conditions that may be useful for recognizing an interaction by a user with a virtual user interface

The smart glasses 800 may include a processing system 812 that includes processing and communication SOCs 202, 204 which may include one or more processors (e.g., 212, 214, 216, 218, 260, 312, 410) one or more of which may be configured with processor-executable instructions to perform operations of various embodiments. The processing and communications SOCs 202, 204 may be coupled to internal sensors 820, internal memory 822, and communication circuitry 824 coupled one or more antenna 826 for establishing a wireless data link. The processing and communication SOCs 202, 204 may also be coupled to sensor interface circuitry 828 configured to control and receive data from a camera 835, microphone(s) 810, and other sensors positioned on the frame 802.

The internal sensors 820 may include an inertial measurement unit (IMU) that includes electronic gyroscopes, accelerometers, and a magnetic compass configured to measure movements and orientation of the wearer's head. The internal sensors 820 may further include a magnetometer, an altimeter, an odometer, and an atmospheric pressure sensor, as well as other sensors useful for determining the orientation and motions of the smart glasses 800. The processing system 812 may further include a power source such as a rechargeable battery 830 coupled to the SOCs 202, 204 as well as the external sensors on the frame 802.

The processors implementing various embodiments may be any programmable microprocessor, microcomputer or multiple processor chip or chips that can be configured by software instructions (applications) to perform a variety of functions, including the functions of the various embodiments described in this application. In some communication devices, multiple processors may be provided, such as one processor dedicated to wireless communication functions and one processor dedicated to running other applications. Typically, software applications may be stored in the internal memory before they are accessed and loaded into the processor. The processor may include internal memory sufficient to store the application software instructions.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the methods and operations methods 300 and 500a-500f may be substituted for or combined with one or more operations of the methods 300 and 500a-500f.

Implementation examples are described in the following paragraphs. While some of the following implementation examples are described in terms of example methods, further example implementations may include: the example methods discussed in the following paragraphs implemented by a computing device including a processor configured with processor-executable instructions to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1. A method performed by a computing device for dynamically rendering elements in virtual environments rendered by the computing device, including monitoring interactions of participants in a virtual environment related to an element presented in the virtual environment, identifying an agreement about the element between at least two of the participants based on the interactions, and altering a presentation of the element in the virtual environment based on the agreement about the element.

Example 2. The method of example 1, in which the interactions of the participants in the virtual environment are related one or more of a visible aspect, an audible aspect, or a tactile aspect of the element.

Example 3. The method of either of examples 1 and 2, in which identifying the agreement about the element between at least two of the participants based on the interactions is performed based on one or more of words spoken in the virtual environment, user gestures performed in the virtual environment, user emotions detected in the virtual environment, or text conveyed in the virtual environment.

Example 4. The method of any of examples 1-3, in which altering the presentation of the element in the virtual environment based on the agreement about the element further includes determining a parameter of the element to alter based on the interactions, and altering the presentation of the parameter of the element in the virtual environment based on the agreement.

Example 5. The method of any of examples 1-4, in which altering the presentation of the element in the virtual environment based on the agreement about the element includes generating two or more renderings of the element based on the interactions, selecting one of the two or more renderings of the element based on the agreement about the element, and rendering the selected one of the two or more renderings of the element in the virtual environment.

Example 6. The method of any of examples 1-5, further including identifying a disagreement about the element based on the interactions, and generating two or more renderings of the element based on the disagreement about the element.

Example 7. The method of example 6, in which identifying the agreement about the element includes identifying a selection by the participants of one of the two or more renderings of the element that were generated based on the disagreement about the element.

Example 8. The method of any of examples 1-7, further including updating user preference data of at least one of the participants based on the identified agreed-upon element.

Example 9. The method of any of examples 1-8, further including updating a generative model used for generating elements of the virtual environment based on the identified agreement about the element.

Example 10. The method of any of examples 1-9, in which identifying the agreement about the element includes applying a large language model to words conveyed in the interactions, and receiving as an output from the large language model an identification of the agreement about the element.

Example 11. The method of any of examples 1-10, in which altering the presentation of the element in the virtual environment based on the agreement about the element is performed using a personalized generative model that is based on user data.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method performed by a computing device for dynamically rendering elements in virtual environments rendered by the computing device, comprising:
monitoring interactions of participants in a virtual environment related to an element presented in the virtual environment;
identifying an agreement about the element between at least two of the participants based on the interactions; and
altering a presentation of the element in the virtual environment based on the agreement about the element.

2. The method of claim 1, wherein the interactions of the participants in the virtual environment are related one or more of a visible aspect, an audible aspect, or a tactile aspect of the element.

3. The method of claim 1, wherein identifying the agreement about the element between at least two of the participants based on the interactions is performed based on one or more of words spoken in the virtual environment, user gestures performed in the virtual environment, user emotions detected in the virtual environment, or text conveyed in the virtual environment.

4. The method of claim 1, wherein altering the presentation of the element in the virtual environment based on the agreement about the element further comprises:
determining a parameter of the element to alter based on the interactions; and
altering the presentation of the parameter of the element in the virtual environment based on the agreement.

5. The method of claim 1, wherein altering the presentation of the element in the virtual environment based on the agreement about the element comprises:
generating two or more renderings of the element based on the interactions;
selecting one of the two or more renderings of the element based on the agreement about the element; and
rendering the selected one of the two or more renderings of the element in the virtual environment.

6. The method of claim 1, further comprising:
identifying a disagreement about the element based on the interactions; and
generating two or more renderings of the element based on the disagreement about the element.

7. The method of claim 6, wherein identifying the agreement about the element comprises identifying a selection by the participants of one of the two or more renderings of the element that were generated based on the disagreement about the element.

8. The method of claim 1, further comprising updating user preference data of at least one of the participants based on the identified agreed-upon element.

9. The method of claim 1, further comprising updating a generative model used for generating elements of the virtual environment based on the identified agreement about the element.

10. The method of claim 1, wherein identifying the agreement about the element comprises:
applying a large language model to words conveyed in the interactions; and
receiving as an output from the large language model an identification of the agreement about the element.

11. The method of claim 1, wherein altering the presentation of the element in the virtual environment based on the agreement about the element is performed using a personalized generative model that is based on user data.

12. A computing device, comprising:
a processing system configured to:
monitor interactions of participants in a virtual environment related to an element presented in the virtual environment;
identify an agreement about the element between at least two of the participants based on the interactions; and
alter a presentation of the element in the virtual environment based on the agreement about the element.

13. The computing device of claim 12, wherein the processing system is further configured such that the interactions of the participants in the virtual environment are related one or more of a visible aspect, an audible aspect, or a tactile aspect of the element.

14. The computing device of claim 12, wherein the processing system is further configured to identify the agreement about the element between at least two of the participants based on the interactions that include on one or more of words spoken in the virtual environment, user gestures performed in the virtual environment, user emotions detected in the virtual environment, or text conveyed in the virtual environment.

15. The computing device of claim 12, wherein the processing system is further configured to:
determine a parameter of the element to alter based on the interactions; and
alter the presentation of the parameter of the element in the virtual environment based on the agreement.

16. The computing device of claim 12, wherein the processing system is further configured to:
generate two or more renderings of the element based on the interactions;
select one of the two or more renderings of the element based on the agreement about the element; and
render the selected one of the two or more renderings of the element in the virtual environment.

17. The computing device of claim 12, wherein the processing system is further configured to:
identify a disagreement about the element based on the interactions; and
generate two or more renderings of the element based on the disagreement about the element.

18. The computing device of claim 17, wherein the processing system is further configured to identify a selection by the participants of one of the two or more renderings of the element that were generated based on the disagreement about the element.

19. The computing device of claim 12, wherein the processing system is further configured to update user preference data of at least one of the participants based on the identified agreed-upon element.

20. The computing device of claim 12, wherein the processing system is further configured to update a generative model used for generating elements of the virtual environment based on the identified agreement about the element.

21. The computing device of claim 12, wherein the processing system is further configured to:
apply a large language model to words conveyed in the interactions; and
receive as an output from the large language model an identification of the agreement about the element.

22. The computing device of claim 12, wherein the processing system is further configured to alter the presentation of the element in the virtual environment based on the agreement about the element using a personalized generative model that is based on user data.

23. A computing device, comprising:
means for monitoring interactions of participants in a virtual environment related to an element presented in the virtual environment;
means for identifying an agreement about the element between at least two of the participants based on the interactions; and
means for altering a presentation of the element in the virtual environment based on the agreement about the element.

24. The computing device of claim 23, wherein the interactions of the participants in the virtual environment are related one or more of a visible aspect, an audible aspect, or a tactile aspect of the element.

25. The computing device of claim 23, wherein means for identifying the agreement about the element between at least two of the participants comprises wherein means for identifying the agreement about the element between at least two of the participants using one or more of words spoken in the virtual environment, user gestures performed in the virtual environment, user emotions detected in the virtual environment, or text conveyed in the virtual environment.

26. The computing device of claim 23, wherein means for altering the presentation of the element in the virtual environment based on the agreement about the element further comprises:
means for determining a parameter of the element to alter based on the interactions; and
means for altering the presentation of the parameter of the element in the virtual environment based on the agreement.

27. The computing device of claim 23, wherein means for altering the presentation of the element in the virtual environment based on the agreement about the element comprises:
means for generating two or more renderings of the element based on the interactions;
means for selecting one of the two or more renderings of the element based on the agreement about the element; and
means for rendering the selected one of the two or more renderings of the element in the virtual environment.

28. The computing device of claim 23, further comprising:
means for identifying a disagreement about the element based on the interactions; and
means for generating two or more renderings of the element based on the disagreement about the element.

29. The computing device of claim 28, wherein means for identifying the agreement about the element comprises means for identifying a selection by the participants of one of the two or more renderings of the element that were generated based on the disagreement about the element.

30. A non-transitory processor-readable medium having stored thereon processor-executable instructions configured to cause a processing system in a computing device to perform operations comprising:
monitoring interactions of participants in a virtual environment related to an element presented in the virtual environment;
identifying an agreement about the element between at least two of the participants based on the interactions; and
altering a presentation of the element in the virtual environment based on the agreement about the element.
